(19) United States
(12) Patent Application Publication
(10) Pub. No.: US 2021/0140362 A1
(43) Pub. Date: May 13, 2021

(54) EXHAUST GAS TURBOCHARGER FOR HIGH-PERFORMANCE ENGINE CONCEPTS

(71) Applicant: Volkswagen Aktiengesellschaft, Wolfsburg (DE)

(72) Inventors: Christopher GESSENHARDT, Weferlingen (DE); Dirk HAGELSTEIN, Braunschweig (DE); Tobias CZAPKA, Hamburg (DE)

(73) Assignee: Volkswagen Aktiengesellschaft, Wolfsburg (DE)

(21) Appl. No.: 17/093,540

(22) Filed: Nov. 9, 2020

(30) Foreign Application Priority Data
Nov. 8, 2019 (DE) 10 2019 217 316.0

(51) Int. Cl. F02B 37/02; F01N 13/10; F02C 6/12

(52) U.S. Cl. CPC F02B 37/025; F01N 13/10; F05D 2260/14; F05D 2220/40; F02C 6/12

(57) ABSTRACT

An exhaust gas turbocharger assembly for a turbocharged internal combustion engine with a spiral housing, having at least two separated flow passages, at least one separating tongue separating the adjacent flow passages, and a turbine rotor, wherein the separating tongue is arranged such that the end of the separating tongue, said end facing the turbine rotor, is spaced from the edge of the turbine rotor such that crosstalk between the flow passages in the flow direction occurs upstream of the turbine rotor, wherein a crosstalk cross section A_{ÜS} is determinable depending on the distance between the separating tongue end and the edge of the turbine rotor.

This nonprovisional application claims priority under 35 U.S.C. § 119(a) to German Patent Application No. 10 2019 217 316.0, which was filed in Germany on Nov. 8, 2019, and which is herein incorporated by reference.

### BACKGROUND OF THE INVENTION

### Field of the Invention

The present invention relates to an exhaust gas turbocharger assembly for engines, for example, for high-performance engine concepts.

### Description of the Background Art

In supercharged internal combustion engines with multi-cylinder combustion engines, a common exhaust manifold in the exhaust line, which connects the exhaust ducts to the exhaust gas turbine, leads to a so-called crosstalk of an exhaust pulse of the exhaust gas discharged from one of the combustion chambers to the other combustion chambers. The high specific power requires increasing dethrottling of the exhaust ducts or a reduction in the ejection work. In this context, extended outlet control times are often used in order to achieve an early shift in the opening of the outlet with a comparable outlet closing. Especially when the combustion engine is operated with an increased load, this can lead to an undesirable effect on the operating behavior, because backflow of the exhaust gas from the exhaust manifold into the combustion chambers can occur. This can be associated with an increased residual gas rate in these combustion chambers and thus, for example, in gasoline engines with an increased tendency to knock and consequently with a reduction in the combustion efficiency and the torque that can be generated. In addition, this results in a later center-of-gravity location and increased exhaust gas temperatures upstream of the turbine. It is generally true that: the larger the outlet control width, the higher the exhaust gas crosstalk and thus also the residual gas rate with an otherwise comparable engine configuration.

In internal combustion engines with exhaust gas turbochargers and separate exhaust gas flow passages, which each connect only part of the combustion chambers to the exhaust gas turbine of the exhaust gas turbocharger, the magnitude of the crosstalk depends to a considerable extent on the design of the exhaust gas turbine. A segmented turbine or turbine with separated flow passages enables, for example, a significant reduction in crosstalk compared with a combination of a single exhaust gas flow passage with a conventional exhaust gas turbine, because the exhaust gas flows routed through the various exhaust gas flow passages only come together in the turbine rotors of the segmented turbines, wherein the exhaust gas flows are also introduced into turbine rotors in different turbine rotor circumferential sections, which are usually offset by 180° with respect to the axes of rotation. However, in combination with separated exhaust gas flow passages, segmented turbines cause a high exhaust gas back pressure due to their principle, because the exhaust gas quantities expelled from the combustion chambers in the individual exhaust strokes only flow through part of the total flow volumes provided by the exhaust gas flow passages and the exhaust gas turbine. High exhaust gas back pressures usually result in high exhaust losses, increased residual gas rates, and, as a result, increased knocking tendencies of the combustion engines.

Use of separated exhaust gas flow passages in combination with a twin-scroll turbine of an exhaust gas turbocharger also enables a reduction in crosstalk between the combustion chambers; however, this occurs to a lesser extent compared with a segmented turbine, because in twin-scroll exhaust gas turbochargers the separated exhaust gas flows are only offset axially with respect to the axis of rotation of the turbine rotor, but at the same time are usually introduced over (approximately) the full circumference of the turbine rotor and consequently parallel into the turbine rotor. Because even with a combination of separated exhaust gas flow passages and a twin-scroll turbine, the individual exhaust gas flows only flow through part of the flow volumes made available in total by the exhaust gas flow passages and the exhaust gas turbine (inlet side), such a combination also leads to an increased exhaust gas back pressure, which, however, is usually slightly lower than with a segmented turbine.

The concepts mentioned result in complex turbine housing geometries, however, with reduced temperature resistance and increased pressure losses in the turbine housing. In comparison with the dual-volute assembly (turbine with separated flow passages), the twin scroll can only achieve a shorter run length of the flow passage division. In the case of the dual-volute variant, there is also a radial alternating load on the turbine rotor as a result of the partial admission.

In order to reduce the disadvantages mentioned, so-called wastegate concepts were developed, which provide a bypass between the flow passages or between the scrolls. However, wastegate concepts have the known disadvantage that, particularly in the rated power range, high efficiency losses arise as a result of the bypassing of the exhaust gas mass flow and, furthermore, the flow passage separation is completely eliminated.

A flow passage connection valve offers a further possibility for reducing the aforementioned disadvantages, as a result of which it is not absolutely necessary to open the wastegate. They primarily reduce the damming behavior of the turbine and enable a greater exhaust gas crosstalk. The flow passage connection valve for its part, however, has package disadvantages and manufacturing and thereby cost disadvantages and is subject to high thermal loads.

Another approach to reducing the aforementioned disadvantages of generic exhaust gas turbochargers is described in the international patent applications WO 2015/179353 A1 and WO 2018/175678 A1. Here a dual-volute turbocharger assembly is disclosed, wherein the flow passages are each directed with a pulse charge against a tongue disposed in the channel of the flow passage. The tongues are offset from one another by approximately 180° around the axis of rotation of the turbine wheel and, in particular, have the smallest possible distance from the edge of the turbine wheel in order to minimize or completely avoid crosstalk. According to WO 2018/175678 A1, the distance between the second tongue and the turbine wheel should be greater than the distance between the first tongue and the turbine wheel in order to increase the service life of the tongues. As shown in FIG. 3 of WO 2018/175678 A1, the tongues can also be designed as ends, facing the turbine wheel, of the flow passage housing walls.

A generic arrangement of a spiral dual-volute turbocharger is also described in DE 169 53 057 A1. Here the flow passages are separated from one another both axially and radially by partition walls. It is described to allow the intermediate walls to extend into the immediate vicinity of a nozzle ring arranged between the intake chambers and the turbine rotor. Overflow losses between the flow passages should be avoided.

The aim of previous dual-volute concepts therefore is to maintain the flow passage separation for as long as possible and to minimize the crosstalk cross section between the flow passages in order to enable an improved low-end torque and dynamic performance via an improved exhaust pulse utilization. Longer run lengths of the exhaust pulses are unfavorable in this case, although they enable the increasing dethrottling of the exhaust ducts as required for a high specific power or the reduction of the ejection work. In this context, extended outlet control times are often used in order to achieve an early shift of the outlet opening with a comparable outlet closing, which can lead to crosstalk of the exhaust gas between the cylinders, as already explained above.

The known concepts have some disadvantages, however, particularly at high engine speeds in the rated power range, such as, for example, partial admission to the turbine rotor, thus an increased damming behavior and radial alternating loading of the turbine rotor.

### SUMMARY OF THE INVENTION

It is therefore an object of the present invention to provide an exhaust gas turbocharger assembly with a spiral housing comprising at least two separated flow passages, which overcome the aforementioned disadvantages, in particular with regard to the reduction or avoidance of an increased tendency to knock and consequently a reduction in the combustion efficiency and the torque that can be generated at high specific powers.

The invention comprises an exhaust gas turbocharger assembly for a turbocharged internal combustion engine with a spiral housing, having at least two separated flow passages, at least one separating tongue separating the adjacent flow passages, and a turbine rotor, wherein the separating tongue is arranged such that the end of the separating tongue, said end facing the turbine rotor, is spaced from the edge of the turbine rotor such that crosstalk between the flow passages in the flow direction occurs upstream of the turbine rotor, wherein a crosstalk cross section A_{ÜS} is determinable depending on the distance d_{TT} between the separating tongue end and the edge of the turbine rotor.

According to the invention, it is provided that the exhaust gas turbocharger assembly has a relative crosstalk cross section A_{REL}=A_{ÜS}/A_{TR} greater than or equal to 0.06, preferably greater than or equal to 0.10, where A_{TR} indicates the outlet cross section at the turbine rotor.

In other words, a core idea of the present invention is to provide a dual-volute concept, but in a way that departs from existing solutions with a maximum crosstalk cross section between the individual flow passages at the turbine wheel. Thus, the entire rotor circumference is available for the through-flow for each pulse. As a result, it is possible to reduce the damming behavior and at the same time to improve the residual gas flushing, especially at the rated power.

Maximizing the crosstalk cross section between the individual flow passages leads to a reduction in the time-averaged exhaust gas back pressure upstream of the turbine. The concept is therefore primarily suitable for optimizing the rated power range.

In the present case, maximizing of the crosstalk cross section is achieved by increasing the distance between the separating tongue and the turbine rotor. The characterization of the crosstalk cross sections is carried out according to the invention by specifying the relative crosstalk cross sections A_{REL}. The relative crosstalk cross sections A_{REL} describe the area ratio from the sum of the crosstalk cross sections A_{ÜS} relative to the outlet cross section A_{TR} at the turbine wheel.

The exhaust gas turbocharger assembly of the invention is suitable for a turbo-charged internal combustion engine. It is known that an increase in performance or efficiency of internal combustion engines, such as, e.g., gasoline or diesel engines for driving motor vehicles, can be achieved by a turbocharger, also known as a turbo. In the context of the present invention, the term internal combustion engine comprises in particular gasoline engines, but also diesel engines and hybrid internal combustion engines, i.e., internal combustion engines that are operated with a hybrid combustion process, as well as hybrid drives that comprise, in addition to the internal combustion engine, an electric motor that can be connected to the drive of the internal combustion engine and which takes up power from the internal combustion engine or delivers additional power as a connectable auxiliary drive.

Internal combustion engines have a cylinder block and a cylinder head, which are connected to one another to form the cylinders. The cylinder head is usually used to accommodate the valve train. In order to control the gas exchange, an internal combustion engine requires control elements, usually in the form of valves, and actuating devices for actuating these control elements. The valve actuation mechanism required to move the valves, including the valves themselves, is called the valve train. In the course of the gas exchange, the expelling of the combustion gases occurs via the outlet ports of the at least two cylinders and the filling of the combustion chambers, i.e., the drawing in of the fresh mixture or charge air via the inlet ports.

According to the state of the art, the exhaust lines that adjoin the outlet ports are at least partially integrated in the cylinder head and are combined to form a common overall exhaust line or in groups to form two or more overall exhaust lines. The merging of exhaust lines to form an overall exhaust line is referred to as an exhaust manifold in general and within the scope of the present invention.

Exhaust gas turbochargers have an exhaust gas turbine and a compressor. The exhaust gas turbine drives the compressor and increases the air throughput or reduces the intake work of the piston. The exhaust gas turbine draws its drive energy from the residual pressure of the exhaust gas of the internal combustion engine.

The exhaust gas turbocharger assembly for a turbocharged internal combustion engine has a spiral housing. Essential parts of the turbine housing are an intake funnel, a rotor housing with a gas channel that narrows spirally starting from the intake funnel, a connecting flange to the bearing housing with an opening that is large enough for inserting the turbine wheel, and a sealing edge in the area of the intake funnel at which the spiral gas channel ends. It is understood that the parts and geometries acted upon by the exhaust gas flow are fluidically optimized.

According to the invention, the gas channel comprises at least two separated flow passages and at least one separating tongue separating the adjacent flow passages. The separating tongue can be designed as a radially extending intermediate wall of the spiral housing. Embodiments of the supercharged internal combustion engine are advantageous in which the housing wall is an immovable wall fixedly connected to the housing. This design of the housing wall ensures that the heat introduced by the hot exhaust gas into the housing wall is advantageously and sufficiently dissipated into and via the housing.

It is provided according to the invention that the separating tongue is arranged such that the separating tongue end, facing the turbine rotor, is spaced from the edge of the turbine rotor such that crosstalk between the flow passages in the flow direction occurs upstream of the turbine rotor.

In other words, according to the invention, the length of the intermediate wall is chosen such that it does not extend as close as possible to the edge of the turbine as was previously the case, but that a radial or tangential gap is provided in the flow direction upstream of the turbine. As a result, the flow passage separation upstream of the turbine is eliminated to a not inconsiderable degree. Crosstalk of the exhaust gas flows of the individual flow passages within the turbine housing is made possible.

According to the invention, it is provided further that a crosstalk cross section A_{ÜS} is determinable depending on the distance d_{TT} between the separating tongue end and the edge of the turbine rotor.

The crosstalk cross section describes an area that can be determined by the distance d_{TT} between the separating tongue end and the edge of the turbine rotor and based on the height of the housing. In other words, the area of the crosstalk region can be easily determined based on the known geometry of the housing and the flow passages in the area of the gap upstream of the turbine.

In order to be able to better differentiate the spacing of the separating tongue end from the edge of the turbine rotor from the previously known minimum distances, which only served the space requirement and the necessary freedom of the rotor, according to the invention a relative crosstalk cross section A_{REL} is used as a parameter, which indicates the ratio of the crosstalk cross section A_{ÜS} to the outlet cross section on turbine rotor A_{TR}.

The turbine rotor has a turbine rotor outlet area with an outlet cross section for the exhaust gas. This means that the exhaust gas can flow out of the turbine wheel via the outlet cross section. The outlet cross section can be easily determined for a known geometry of a turbine rotor and is determined in particular by the geometry, the distances, and the opening width of the gaps between the turbine blades.

According to the invention, the exhaust gas turbocharger assembly

a. has a relative crosstalk cross section A_{REL}=A_{ÜS}/A_{TR} greater than or equal to 0.06, in particular greater than or equal to 0.1, if the turbine rotor has a fixed turbine geometry, wherein
b. the exhaust gas turbocharger assembly has a relative crosstalk cross section A_{REL}=A_{ÜS}/A_{TR} greater than or equal to 0.1, if the turbine rotor has a variable turbine geometry.

In other words, in the exhaust gas turbocharger assembly of the invention, the area ratio of the crosstalk cross section to the outlet cross section of the turbine rotor is greater than or equal to 10% and in the case of a turbine rotor with a fixed turbine geometry, the crosstalk cross section is greater than or equal to 6%.

The turbine rotor can be a cartridge with variable turbine geometry.

The turbine can basically be provided with a variable turbine geometry which can be adapted by adjustment to the respective operating point of the internal combustion engine. A so-called VTG cartridge comprises rotatable blades and levers and a turbine-housing-side disk as well as a blade bearing ring and an adjusting ring. Such VTG cartridges are generally known and are described, for example, in EP 1236866 A2, U.S. Pat. No. 4,629,396 A, DE 202010015007 U1 or EP 167980 A1 and in EP 1707755 A1 and are used to regulate the boost pressure. The adjustment of the blades to a steep position has the effect that exhaust gas still flows against the turbine wheel at a high circumferential speed even at low exhaust gas quantities, therefore, at a low load and low engine speed, and the losses on the blades due to the entry shock remain small. If the amount of exhaust gas is small, the guide blades are flattened; the result is a smaller cross section in the blades for the exhaust gases. The few exhaust gases must flow faster so that the same amount of exhaust gas can flow through the guide blades in the same time. As a result, the speed of the supercharger is higher in this operating state and the supercharger builds up pressure more quickly when the load changes because it does not have to rev up first.

The crosstalk cross section A_{ÜS} can result from the addition of an outer crosstalk cross section A_{ÜS_outer} and an inner crosstalk cross section A_{ÜS_inner}, wherein the outer crosstalk cross section A_{ÜS_outer} can be determined as a function of the distance between the separating tongue end and the edge of the cartridge with a variable turbine geometry and the inner crosstalk cross section k_{ÜS_inner} can be determined as a function of the tangential annular gap within the cartridge with a variable turbine geometry.

In other words, when a cartridge is used, a maximization of the crosstalk cross section can be achieved by increasing the distance between the separating tongue and the VTG blade inlet, which is described hereafter by the term outer crosstalk cross section, and by increasing the distance between the VTG blade outlet and the turbine rotor (tangential annular gap within the cartridge), which is described hereafter by the term of the inner crosstalk cross section, or by a combination of both increases.

In every case, the flow passage separation should be eliminated before entry into the VTG cartridge. Thus, the entire VTG cartridge and the entire rotor circumference are available for the through-flow for each exhaust pulse. As a result, it is possible to reduce the damming behavior and at the same time to improve the residual gas flushing, especially at the rated power.

Maximizing the crosstalk cross section leads to a reduction in the time-averaged exhaust gas back pressure upstream of the VTG cartridge. The concept is therefore primarily suitable for optimizing the rated power range.

In a further example of this exhaust gas turbocharger assembly of the invention with a variable turbine geometry, the exhaust gas turbocharger assembly has a relative outer crosstalk cross section A_{REL_outer} greater than or equal to 0.1, preferably greater than or equal to 0.2, more preferably greater than or equal to 0.4, determined as the quotient of the outer crosstalk cross section A_{ÜS_outer} and the outlet cross section at the turbine rotor A_{TR}.

In an example of an exhaust gas turbocharger assembly with a variable turbine geometry, it has a relative inner crosstalk cross section A_{REL_inner} greater than or equal to 0.025, preferably approximately 0.03, determined as the quotient of the inner crosstalk cross section A_{ÜS_inner} and the outlet cross section at the turbine rotor A_{TR}.

The present invention also covers configurations in which the outer relative crosstalk cross section is rather small, for example <5%, and the crosstalk desired according to the invention in the exhaust gas turbocharger takes place by increasing the inner relative crosstalk cross section, for example, >10%. However, this can lead to an incorrect inflow onto the turbine rotor and thus to a reduced turbine efficiency.

The exhaust gas turbocharger assembly can have a relative crosstalk cross section A_{REL}=A_{ÜS}/A_{TR} in the range greater than or equal to 0.20, preferably greater than or equal to 0.30, and particularly preferably greater than or equal to 0.40.

In other words, the ratio or the quotient of the crosstalk cross section to the outlet cross section of the turbine rotor is greater than or equal to 20%, preferably greater than or equal to 30%, and particularly preferably greater than or equal to 40%.

Stated differently, the area that is available for the crosstalk of the exhaust gas upstream of the turbine between the flow passages is preferably approximately half the size of the area through which the exhaust gas flows out of the turbine rotor. When a VTG cartridge is used, the crosstalk cross section can include additively the outer and inner crosstalk cross sections: A_{ÜS}=A_{ÜS_outer}+A_{ÜS_inner}.

With the ratios mentioned, a number of advantages are achieved which cannot be achieved in previous turbochargers or cannot be achieved in combination. In this way, the maximum exhaust gas path in the turbine is achieved, wherein at the same time, a good turbine efficiency can be ensured and, moreover, a similar exhaust gas back pressure level of the individual flow passages. This applies in particular in the rated load range of the high-performance internal combustion engine, for which the exhaust gas turbocharger assembly of the invention provides an optimized concept.

The rotation angle of the flow passage segments about the turbine axis (11) is 180°+/−45°, preferably 180°+/−20°, particularly preferably 180°+/−5°.

The avoidance of exhaust gas crosstalk is thus achieved primarily by maximizing the run lengths. Accordingly, the typical design of a dual-volute turbine with a rotation angle of 180° about the turbine axis results in the maximum run length of the exhaust gas pulse between the cylinders.

Rotation angles of the volute segments, which deviate significantly from 180°, are also included according to the invention. These configurations are less efficient in terms of fluid mechanics, as this results in a rather unequal damming behavior of the individual flow passages and a reduced run length between the cylinders.

The invention also relates to an internal combustion engine with exhaust gas turbocharging, comprising an exhaust gas turbocharger assembly according to the invention set forth in more detail above.

The internal combustion engine preferably comprises an exhaust manifold routing which is separated according to the ignition sequence and opens into the exhaust gas turbocharger assembly according to the invention set forth in more detail above.

Embodiments of the supercharged internal combustion engine are advantageous in which the exhaust lines of the cylinders of each cylinder group merge within the cylinder head with the formation of two exhaust manifolds to form an overall exhaust line. The dual-flow passage turbine provided in the exhaust gas discharge system can then be disposed very close to the outlet of the internal combustion engine, i.e., close to the outlet ports of the cylinders. This has a number of advantages, especially because the exhaust lines between the cylinders and the turbine are shortened. Because the path to the turbine for the hot exhaust gases is shortened, the volume of the exhaust manifold or of the exhaust gas discharge system upstream of the turbine also decreases. The thermal inertia of the exhaust gas removal system also decreases by reducing the mass and length of the exhaust gas lines involved. In this way, the exhaust gas enthalpy of the hot exhaust gases, which is largely determined by the exhaust gas pressure and the exhaust gas temperature, can be optimally used and a fast response behavior of the turbine can be guaranteed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows, in a highly schematic illustration, a cross-sectional view of an exemplary dual-volute exhaust gas turbocharger assembly according to the present invention; and

FIG. 2 shows, in a highly schematic illustration, a cross-sectional view of an exhaust gas turbocharger assembly according to the present invention.

### DETAILED DESCRIPTION

FIG. 1 schematically shows the basic structure of an exhaust gas turbocharger assembly 1 cut perpendicular to the axis of rotation 11 of rotor 6. The illustrated turbocharger assembly 1 is an example for a dual-flow passage turbocharger assembly 1, i.e., for a turbocharger assembly 1 with two flow passages 3, 4. Turbocharger assembly 1 has a turbine housing 2 in which a rotor 6 is mounted on a rotatable shaft 11. Turbocharger assembly 1 is characterized in that the two flow passages 3, 4 are arranged one above the other and surround rotor 6 in a spiral shape at least along an arcuate section on radii of different sizes. In other words, housing 2 is designed like a spiral, wherein flow passages 3, 4 are separated by a radial housing wall as a separating tongue 5 and wherein turbine rotor 6 is arranged approximately in the center of the housing (so-called dual-volute concept). The two inlet openings of dual-volute turbine 1 are disposed in a flange of housing 2 radially at different distances from shaft 11 of turbine rotor 6, wherein a flow passage 3, 4 of turbocharger assembly 1 adjoins each inlet opening and the two flow passages 3, 4 are separated from one another by means of a separating tongue 5 up to the vicinity of rotor 6. In this way, the exhaust gas flows of the two flow passages 3, 4 are conducted separately from one another in the direction of rotor 6.

According to the invention, it is provided that separating tongue 5 does not come as close as possible to edge 8 of turbine rotor 6. Rather, according to the invention, a distance between separating tongue end 7 and the edge of turbine rotor 8 is provided, which is marked as d_{TT} in the figures. Depending on the distance d_{TT} between separating tongue end 7 and the edge of turbine rotor 8, a crosstalk cross section A_{ÜS} can be determined, which can be obtained or estimated as area data, for example, by multiplying the distance d_{TT} by the flow passage height multiplied by the number of separator tongues (usually 2).

According to the invention, it is provided for the ratio of the crosstalk cross section A_{ÜS} to the outlet cross section of turbine rotor 6 that exhaust gas turbocharger assembly 1 has such a relative crosstalk cross section A_{REL}=A_{ÜS}/A_{TR} greater than or equal to 0.06, where A_{TR} indicates the outlet cross section at turbine rotor 6. In other words, the area upstream of the turbine that allows crosstalk of the exhaust gas flows with respect to the flow passage separation is at least 6% of the outlet area of the turbine rotor. However, it is preferably greater, for example, greater than 10% of the outlet area, preferably greater than or equal to 20%, and particularly preferably it is 30% or more in relation to the outlet area. As a result, certain advantages are achieved, especially for the range of the rated power and the high speeds of the internal combustion engine, advantages that could not be achieved in particular in combination with previous designs. In addition to a maximum path of the exhaust gas in the turbine, wherein a good turbine efficiency can be ensured at the same time, the same exhaust gas back pressure level of the individual flow passages can also be achieved. With a rotation angle of the flow passage segments about turbine axis 11 of 180°+/−45°, preferably 180°+/−20°, particularly preferably 180°+/−5°, the avoidance of the exhaust gas crosstalk between the cylinders of the internal combustion engine is thus primarily achieved by maximizing the run lengths.

FIG. 2 schematically shows the basic structure of a further embodiment of exhaust gas turbocharger assembly 1 cut perpendicular to the axis of rotation 11 of rotor 6. The illustrated turbocharger assembly 1 is again an example of a dual-flow passage turbocharger assembly 1, i.e., for a turbocharger assembly 1 with two flow passages 3, 4. The same reference symbols as in FIG. 1 designate the same functional components. In contrast to the embodiment in FIG. 1, turbocharger assembly 1 does not have a simple turbine rotor 6, but a cartridge with a variable turbine geometry 9 is disposed in its place. The cartridge with a variable turbine geometry 9 has in its center a turbine rotor 6 which is movably mounted on a shaft 11. There is a blade bearing ring or a carrier ring with adjustable blades around turbine rotor 6 and spaced from it by an annular gap 10.

In an advantageous embodiment of the invention, the crosstalk cross section A_{ÜS} results from the addition of an outer crosstalk cross section A_{ÜS_outer} and an inner crosstalk cross section A_{ÜS_inner}, wherein the outer crosstalk cross section A_{ÜS_outer} can be determined as a function of the distance d_{TT} between the separating tongue end and edge 8 of the cartridge with a variable turbine geometry 9 and the inner crosstalk cross section A_{ÜS_inner} can be determined as a function of the tangential annular gap 10 within the cartridge with a variable turbine geometry 9. Turbocharger assembly 1 in FIG. 2 has a relative crosstalk cross section greater than or equal to 10%.

In other words, when a cartridge 9 is used, a maximization of the crosstalk cross section can be achieved by increasing the distance d_{TT} between the separating tongue and VTG blade inlet 8, which is described hereafter by the term outer crosstalk cross section, and by increasing the distance between the VTG blade outlet and the turbine rotor (tangential annular gap 10 within cartridge 9), which is described hereafter by the term inner crosstalk cross section, or by a combination of both increases.

In every case, the flow passage separation should be eliminated before the entry into VTG cartridge 9. Thus, the entire VTG cartridge 9 and the entire rotor circumference are available for the through-flow for each exhaust gas pulse. As a result, it is possible to reduce the damming behavior and at the same time to improve the residual gas flushing, especially at the rated power. Maximizing the crosstalk cross section leads to a reduction in the time-averaged exhaust gas back pressure upstream of VTG cartridge 9. The concept is therefore primarily suitable for optimizing the rated power range.

In a further embodiment of this exhaust gas turbocharger assembly 1 of the invention with a variable turbine geometry, exhaust gas turbocharger assembly 1 has a relative outer crosstalk cross section A_{REL_outer} greater than or equal to 0.10, preferably greater than or equal to 0.20, more preferably greater than or equal to 0.40, determined as the quotient of the outer crosstalk cross section A_{ÜS_outer} and the outlet cross section at the turbine rotor A_{TR}.

In an embodiment of an exhaust gas turbocharger assembly 1 with a variable turbine geometry, it has a relative inner crosstalk cross section A_{REL_inner} greater than or equal to 0.025, preferably approximately 0.03, determined as the quotient of the inner crosstalk cross section A_{ÜS_inner} and the outlet cross section at the turbine rotor A_{TR}.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. An exhaust gas turbocharger assembly for a turbocharged internal combustion engine, the assembly comprising:
a spiral housing having at least two separated flow passages, the at least two separated flow passages having a portion thereof adjacent to one another;
at least one separating tongue separating the at least two separated flow passages; and
a turbine rotor,
wherein the separating tongue is arranged such that an end of the separating tongue facing the turbine rotor is spaced from the edge of the turbine rotor such that crosstalk between the flow passages in a flow direction occurs upstream of the turbine rotor,
wherein a crosstalk cross section is determinable depending on a distance between the separating tongue end and an edge of the turbine rotor,
wherein the exhaust gas turbocharger assembly has a relative crosstalk cross section A_{REL}=A_{ÜS} A_{TR} greater than or equal to 0.06 or greater than or equal to 0.1, if the turbine rotor has a fixed turbine geometry, and/or
wherein the exhaust gas turbocharger assembly has a relative crosstalk cross section A_{REL}=A_{ÜS} A_{TR} greater than or equal to 0.1, if the turbine rotor has a variable turbine geometry,
where A_{TR} indicates the outlet cross section at the turbine rotor.

2. The exhaust gas turbocharger assembly according to claim 1, wherein the crosstalk cross section A_{ÜS} results from the addition of an outer crosstalk cross section A_{ÜS_outer} and an inner crosstalk cross section A_{ÜS_inner}, wherein the outer crosstalk cross section A_{ÜS_outer} is determined as a function of the distance between the separating tongue end and the edge of the cartridge with a variable turbine geometry and the inner crosstalk cross section A_{ÜS_inner} is determined as a function of the tangential annular gap within the cartridge with a variable turbine geometry.

3. The exhaust gas turbocharger assembly according to claim 1, wherein the exhaust gas turbocharger assembly has a relative crosstalk cross section A_{REL}=A_{ÜS}/A_{TR} in a range greater than or equal to 0.20, greater than or equal to 0.30, or greater than or equal to 0.40.

4. The exhaust gas turbocharger assembly according to claim 1, wherein the exhaust gas turbocharger assembly has a relative outer crosstalk cross section A_{REL_outer} greater than or equal to 0.10, greater than or equal to 0.20, or greater than or equal to 0.40, determined as the quotient of the outer crosstalk cross section A_{ÜS_outer} and the outlet cross section at the turbine rotor A_{TR}.

5. The exhaust gas turbocharger assembly according to claim 1, wherein the exhaust gas turbocharger assembly has a relative inner crosstalk cross section A_{REL_inner} greater than or equal to 0.025, or approximately 0.03 determined as the quotient of the inner crosstalk cross section A_{ÜS_inner} and the outlet cross section at the turbine rotor A_{TR}.

6. The exhaust gas turbocharger assembly according to claim 1, wherein a rotation angle of the flow passage segments about the turbine axis is 180°+/−45°, 180°+/−20°, or 180°+/−5°.

7. An internal combustion engine with exhaust gas turbocharging comprising an exhaust gas turbocharger assembly according to claim 1.

8. The internal combustion engine according to claim 7, comprising an exhaust manifold routing which is separated according to the ignition sequence and opens into the exhaust gas turbocharger assembly.
